(19) United States
(12) Patent Application Publication
(10) Pub. No.: US 2020/0302402 A1
(43) Pub. Date: Sep. 24, 2020

(54) NON-TRANSITORY STORAGE MEDIUM, INFORMATION PROCESSING METHOD, AND INFORMATION PROCESSING APPARATUS

(71) Applicant: TOYOTA JIDOSHA KABUSHIKI KAISHA, Toyota-shi (JP)

(72) Inventors: Takashige HORI, Aisai-shi (JP); Naoto SASAGAWA, Nishio-shi (JP)

(73) Assignee: TOYOTA JIDOSHA KABUSHIKI KAISHA, Toyota-shi (JP)

(21) Appl. No.: 16/790,835

(22) Filed: Feb. 14, 2020

(30) Foreign Application Priority Data
Mar. 19, 2019 (JP) 2019-050893

(51) Int. Cl. G06Q 10/10

(52) U.S. Cl. CPC G06Q 10/1093

(57) ABSTRACT

A non-transitory storage medium stores a program causing an information processing apparatus to execute acquiring first climate information indicating a climate at a date and time related to a first schedule registered in a schedule table in which at least one schedule including a date and time, a genre, and a place is registered, determining whether or not the first climate information satisfies a climate compatibility condition, and outputting incompatibility information indicating that the climate at the date and time related to the first schedule is not compatible with a genre related to the first schedule when determination is made that the first climate information does not satisfy the climate compatibility condition.

### INCORPORATION BY REFERENCE

The disclosure of Japanese Patent Application No. 2019-050893 filed on Mar. 19, 2019 including the specification, drawings and abstract is incorporated herein by reference in its entirety.

### BACKGROUND

### 1. Technical Field

The disclosure relates to a non-transitory storage medium, an information processing method, and an information processing apparatus.

### 2. Description of Related Art

Schedule management software for managing a schedule has been used. In such schedule management software, for example, activities of various contents are registered together with a scheduled date and time for performing the activity.

For example, Japanese Unexamined Patent Application Publication No. 2018-041289 (JP 2018-041289 A) discloses a schedule management program causing a computer to refer to a storage unit that stores screen layout information in association with a task or event type to execute processing of specifying a screen layout corresponding to a specified task or event type.

### SUMMARY

However, there may be an activity that is adversely affected by a climate in activities registered in a schedule, and the schedule itself may be canceled in the worst case.

The disclosure provides a schedule management technique capable of reducing an adverse effect of a climate on a schedule.

An aspect of the disclosure provides a non-transitory storage medium storing a program. The program according to the aspect of the disclosure causes an information processing apparatus to execute acquiring first climate information indicating a climate at a date and time related to a first schedule registered in a schedule table in which at least one schedule including a date and time, a genre, and a place is registered, determining whether or not the first climate information satisfies a climate compatibility condition, and outputting incompatibility information indicating that the climate at the date and time related to the first schedule is not compatible with a genre related to the first schedule when determination is made that the first climate information does not satisfy the climate compatibility condition.

According to the aspect, since the user can change the schedule as appropriate based on the incompatibility information, it is possible to reduce the adverse effect of the climate on the schedule.

According to the disclosure, it is possible to provide the schedule management technique capable of reducing the adverse effect of the climate on the schedule.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram showing an example of a configuration of an information processing apparatus 1 according to an embodiment;

FIG. 2 is a table showing an example of a data configuration of a schedule table;

FIG. 3 is a table showing an example of a data configuration of an inappropriate climate table;

FIG. 4A is a diagram showing an example of an operation flow of the information processing apparatus 1;

FIG. 4B is a diagram showing an example of an operation flow of the information processing apparatus 1;

FIG. 5 is a diagram showing an example of an incompatibility notification screen 300;

FIG. 6 is a diagram showing an example of a schedule movement proposal screen 400; and

FIG. 7 is a diagram showing an example of a schedule exchange proposal screen 500.

### DETAILED DESCRIPTION OF EMBODIMENTS

Preferred embodiments will be described with reference to accompanying drawings. (an element to which the same reference numeral is assigned has the same or similar configuration in each drawing)

(1) Configuration

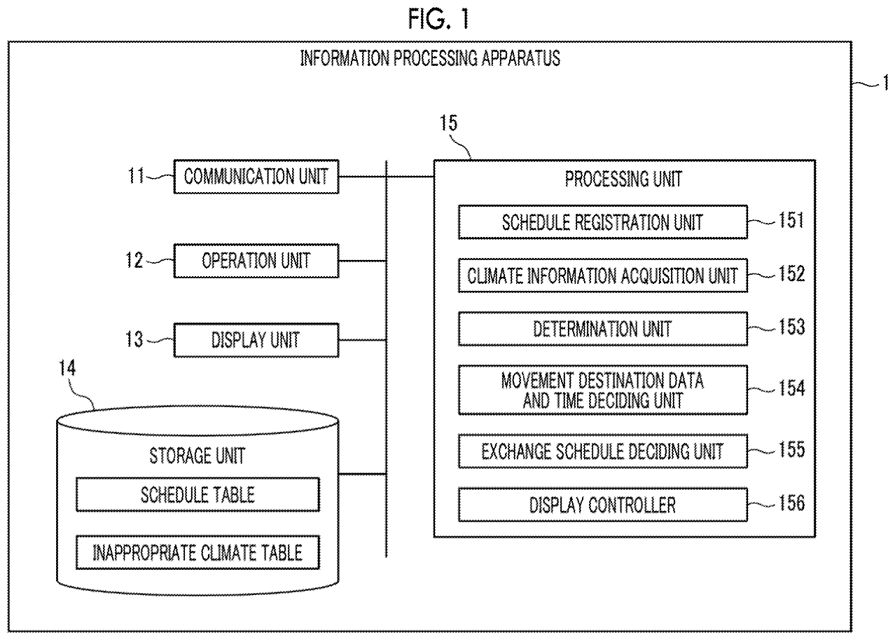

FIG. 1 is a diagram showing an example of a configuration of an information processing apparatus 1 according to the embodiment. The information processing apparatus 1 according to the embodiment is an information processing apparatus to manage a schedule of a user, for example. For this purpose, the information processing apparatus 1 includes, for example, a communication unit 11, an operation unit 12, a display unit 13, a storage unit 14, and a processing unit 15.

The communication unit 11 includes a communication interface circuit and connects the information processing apparatus 1 to a communication network. The communication unit 11 transmits data supplied from the processing unit 15 to another information processing apparatus or the like through the communication network. The communication unit 11 supplies data received from another information processing apparatus or the like to the processing unit 15 through the communication network.

The operation unit 12 may be any device as long as the information processing apparatus 1 can be operated, such as a touch panel or a key button. The user can input a character, a number, a symbol, or the like using the operation unit 12. When the user operates the operation unit 12, the operation unit 12 generates a signal corresponding to the operation. The generated signal is supplied to the processing unit 15 as a user instruction.

The display unit 13 may be any device as long as a video, an image, or the like can be displayed, such as a liquid crystal display or an organic electro-luminescence (EL) display. The display unit 13 displays a video corresponding to video data, an image corresponding to image data, or the like supplied from the processing unit 15.

The storage unit 14 includes, for example, a semiconductor memory apparatus. The storage unit 14 stores an operating system program, a driver program, an application program, data, and the like used for processing in the processing unit 15. For example, the storage unit 14 stores an input device driver program that controls the operation unit 12, an output device driver program that controls a store terminal display unit 34, and the like, as driver programs. In addition, the storage unit 14 stores a predetermined schedule management program and the like as the application program. The various programs may be installed in the storage unit 14 from a computer-readable portable recording medium such as a CD-ROM or DVD-ROM using a known setup program or the like. Further, the storage unit 14 may temporarily store temporary data related to predetermined processing. In addition, the storage unit 14 may store a schedule table and an inappropriate climate table.

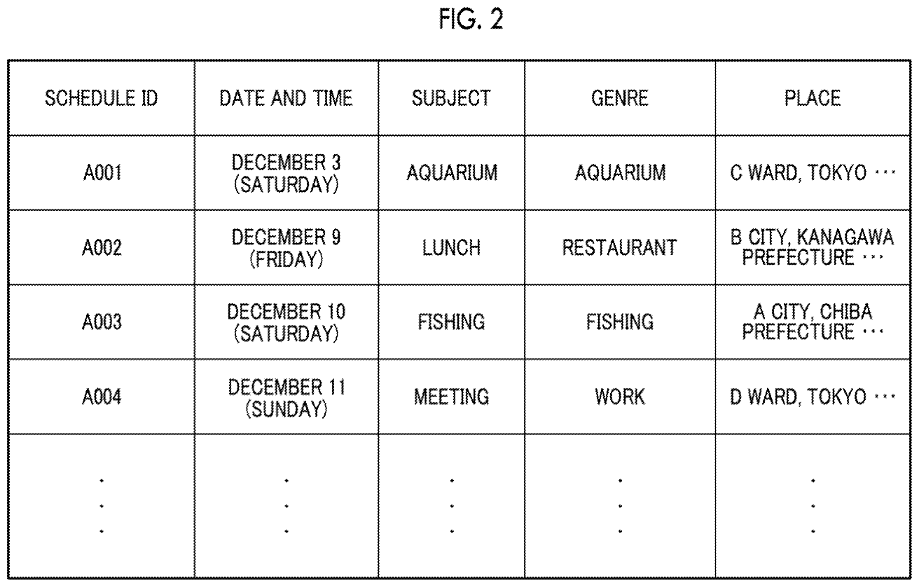

FIG. 2 is a table showing an example of a data configuration of the schedule table. The schedule table is a table for managing the schedule of the user. As shown in FIG. 2, the schedule table includes items such as “schedule ID”, “date and time”, “subject”, “genre”, and “place”. Each item of the schedule table shown in FIG. 2 is an example, and the schedule table may have another item.

The “schedule ID” is identification information (ID) for identifying a schedule. The “date and time” is information indicating a time at which the schedule is performed and may include, for example, a date, a start timepoint, an end timepoint, and the like. The “subject” is a name representing the schedule randomly input by the user, for example. The “genre” is information indicating a genre (outline, attribute information, or the like) of an activity of the schedule. The “place” is information indicating a place where the schedule randomly input by the user is performed, for example.

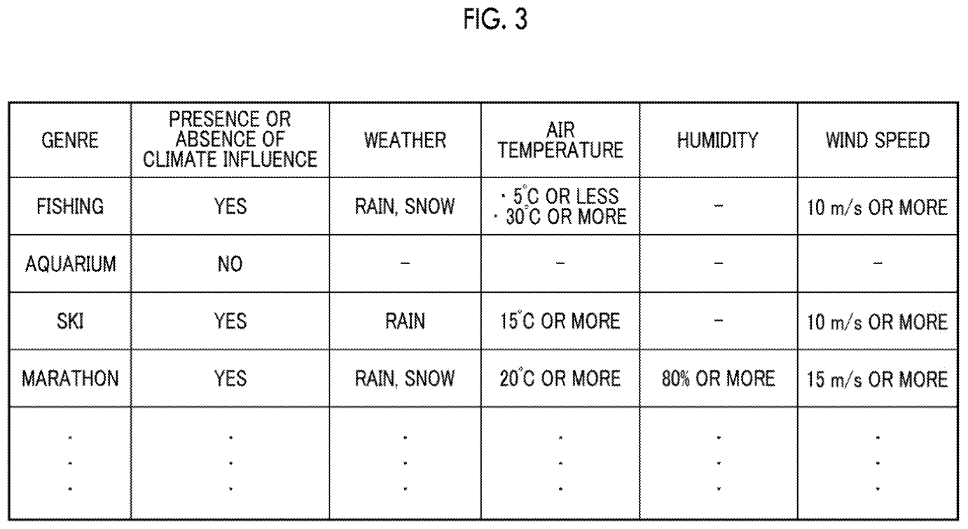

FIG. 3 is a table showing an example of a data configuration of the inappropriate climate table. The inappropriate climate table is an example of a predetermined table that defines the standard of a degree of compatibility of a climate and is a table that defines contents of an inappropriate climate for each genre of the schedule. As shown in FIG. 3, the inappropriate climate table may include, for example, “genre”, “presence or absence of climate influence”, “weather”, “air temperature”, “humidity”, “wind speed”, and the like. Each item in the inappropriate climate table shown in FIG. 3 is an example, and may include another item or may be randomly set by the user or the like. The predetermined table that defines the standard of the degree of compatibility of the climate is not limited to the table that defines the contents of inappropriate climate and may be a table that defines contents of an appropriate climate.

The “genre” is information indicating a genre of the activity. The “presence or absence of climate influence” is information indicating whether or not the schedule is affected by the climate. The “presence or absence of climate influence” may include, for example, “Yes” indicating that the schedule is affected by the climate and “No” indicating that the schedule is not affected by the climate. The “weather” is an element of the climate and is information indicating an atmospheric state. The “weather” may include at least any one of, for example, “clear”, “sunny”, “lightly cloudy”, “cloudy”, “smoke”, “sand dust”, “drifting snow”, “mist”, “drizzle”, “rain”, “sleet”, “snow”, “hail”, “hailstone”, and “thunder”. The “air temperature” is an element of the climate and is information indicating an atmospheric temperature. The “humidity” is an element of the climate and is a degree to which air contains water vapor. The “wind speed” is an element of the climate and is a speed at which air moves as wind.

The processing unit 15 includes one or a plurality of processors and peripheral circuits thereof. The processing unit 15 integrally controls the overall operation of the information processing apparatus 1 and is, for example, a CPU. The processing unit 15 controls the operation of the communication unit 11, the display unit 13, or the like such that various types of processing of the information processing apparatus 1 are executed in an appropriate procedure based on the programs stored in the storage unit 14, the operation of the operation unit 12, or the like. The processing unit 15 executes the processing based on the program (operating system program, driver program, application program, or the like) stored in the storage unit 14. The processing unit 15 can execute a plurality of programs (application program and the like) in parallel. The processing unit 15 includes a schedule registration unit 151, a climate information acquisition unit 152, a determination unit 153, a movement destination date and time deciding unit 154, an exchange schedule deciding unit 155, and a display controller 156.

(2) Operation

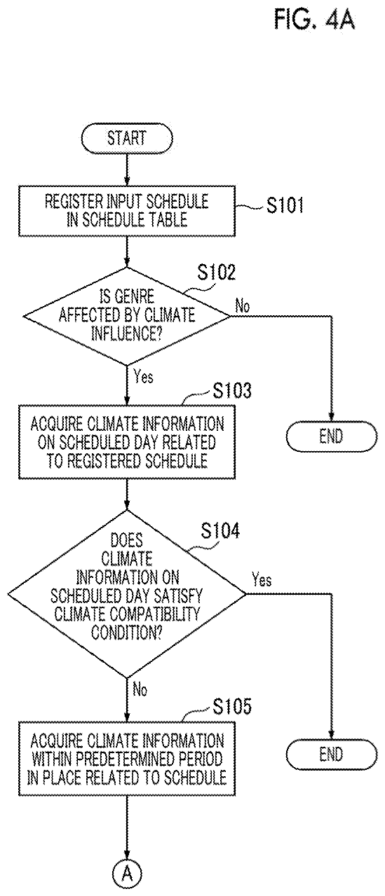

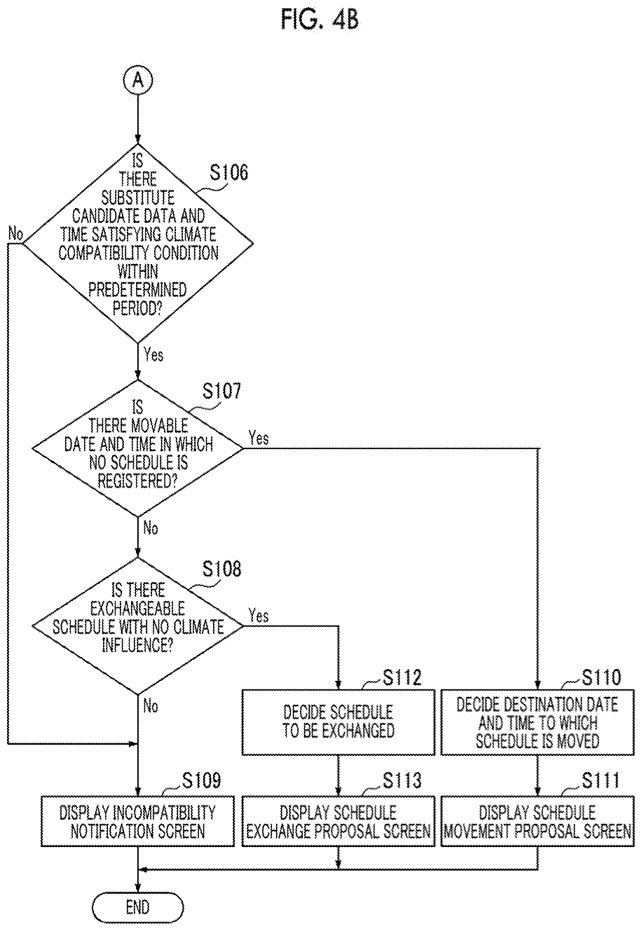

FIGS. 4A and 4B are diagrams showing an example of an operation flow of the information processing apparatus 1. The operation flow is executed mainly by the processing unit 15 in cooperation with each element of the information processing apparatus 1 based on the program stored in the storage unit 14 in advance.

(S101) First, when the user inputs a schedule through the operation unit 12, the schedule registration unit 151 registers the input schedule in the schedule table. Specifically, the user inputs various items of the schedule including, for example, a date and time, a genre, and a place related to the schedule. In the example, for example, the user is assumed to input a schedule of the date and time “December 10 (Saturday)”, the genre “fishing”, and the place “A” on December 1 (Thursday).

(S102) Next, the determination unit 153 refers to a column “presence or absence of climate influence” in the inappropriate climate table to determine whether or not the genre related to the registered schedule is a genre that is affected by the climate. When the genre related to the registered schedule is not affected by the climate (S102; No), the processing ends. When the genre related to the registered schedule is affected by the climate (S102; Yes), the processing proceeds to S103. In the example, the “presence or absence of climate influence” of the genre “fishing” is “Yes” in the inappropriate climate table. Therefore, the processing proceeds to S103 as the case where there is an influence due to the climate (S102; Yes).

(S103) Next, the climate information acquisition unit 152 acquires climate information (information indicating climate forecast) on the scheduled day related to the schedule. In the case, the climate information acquisition unit 152 may acquire desired climate information from an external database through the communication unit 11. In the example, the climate information acquisition unit 152 is assumed to acquire “weather; rain”, “air temperature: 7 degrees”, “humidity: 80%”, and “wind speed; 5 m/s” as the climate information on December 10 (Saturday) which is the scheduled day.

(S104) Next, the determination unit 153 refers to a column of the genre related to the schedule in the inappropriate climate table to determine whether or not a predetermined climate compatibility condition indicating that the climate information on the scheduled day is compatible with the genre related to the schedule is satisfied.

Here, the climate compatibility condition may be that the climate information does not correspond to one or a plurality of specific columns in the inappropriate climate table. That is, for example, when the specific column is solely “weather”, the climate compatibility condition may be determined to be satisfied when “weather” in the climate information does not correspond to the “weather” column in the inappropriate climate table. Alternatively, for example, when the specific column is “weather” and “air temperature”, the climate compatibility condition may be determined to be satisfied when “weather” and “air temperature” in the climate information do not correspond to the “weather” and “air temperature” columns in the inappropriate climate table. The user or the like may randomly set which column in the inappropriate climate table is used for determining the climate compatibility condition. The column used for determining the climate compatibility condition may be different depending on the genre.

When the climate information on the scheduled day is determined to satisfy the climate compatibility condition (S104; Yes), the processing ends. When determination is made that the climate information on the scheduled day does not satisfy the climate compatibility condition (S104; No), the processing proceeds to S105. In the example, for example, the climate compatibility condition is assumed to be determined solely by the column “weather”. The weather in the climate information on December 10 (Saturday) which is the scheduled day described above is “rain” and the weather of “rain” coincides with “rain” which is the weather of the genre “fishing” in the inappropriate climate table. Therefore, the determination unit 153 determines that the climate compatibility condition is not satisfied.

(S105) When the determination is made that the climate information on the scheduled day does not satisfy the climate compatibility condition (S104; No), the climate information acquisition unit 152 acquires climate information within a predetermined period in a place related to the schedule (climate incompatibility schedule).

Here, a start point or length of the predetermined period is not particularly limited. For example, the start point may be the present, the length may be one month, or the like. When the climate information for the predetermined period is not available from an external database or the like, climate information estimated from past statistical information may be acquired from another external database or the like. In the example, for example, the predetermined period is set from December 1 (Thursday) which is the present to January 1 (Sunday) which is one month ahead. The climate information acquisition unit 152 is assumed to acquire the climate information within the predetermined period in the place “A” related to the schedule.

(S106) Next, the determination unit 153 determines whether or not there is a date and time (substitute candidate date and time) that satisfies the climate compatibility condition within the predetermined period based on the climate information for the predetermined period acquired in S105. When determination is made that there is the date and time (substitute candidate date and time) that satisfies the climate compatibility condition within the predetermined period (S106; Yes), the processing proceeds to S107. When determination is made that there is no date and time (substitute candidate date and time) that satisfies the climate compatibility condition within the predetermined period (S106; No), the processing proceeds to S109.

(S107) When the determination is made that there is the date and time (substitute candidate date and time) that satisfies the climate compatibility condition within the predetermined period described above (S106; Yes), the determination unit 153 determines whether or not there is a date and time (movable date and time) in which no schedule is registered among the dates and times (substitute candidate dates and times) that are determined to satisfy the climate compatibility condition. When determination is made that there is the date and time in which no schedule is registered among the dates and times (substitute candidate dates and times) that are determined to satisfy the climate compatibility condition (S107; Yes), the processing proceeds to S110. When determination is made that there is no date and time in which no schedule is registered among the dates and times (substitute candidate dates and times) that are determined to satisfy the climate compatibility condition (S107; No), the processing proceeds to S108.

(S108) When the determination is made that there is no date and time (movable date and time) in which no schedule is registered among the dates and times (substitute candidate dates and times) that are determined to satisfy the climate compatibility condition (S107; No), some schedules are registered for all the dates and times (substitute candidate dates and times) that are determined to satisfy the climate compatibility condition. In the case, the determination unit 153 refers to the inappropriate climate table to determine whether or not there is a schedule (exchangeable schedule) that the “presence or absence of climate influence” is “No” among the schedules registered on the dates and times (substitute candidate dates and times) that are determined to satisfy the climate compatibility condition in this manner.

When determination is made that there is the schedule (exchangeable schedule) that the “presence or absence of climate influence” is “No” among the schedules registered on the dates and times (substitute candidate dates and times) that are determined to satisfy the climate compatibility condition (S108; Yes), the processing proceeds to S112. When determination is made that there is no schedule (exchangeable schedule) that the “presence or absence of climate influence” is “No” among the schedules registered on the dates and times (substitute candidate dates and times) that are determined to satisfy the climate compatibility condition (S108; No), the processing proceeds to S109.

(S109) When the determination is made that there is no date and time (substitute candidate date and time) that satisfies the climate compatibility condition within the predetermined period (S106; No), or when the determination is made that there is no schedule (exchangeable schedule) that the “presence or absence of climate influence” is “No” among the schedules registered on the dates and times (substitute candidate dates and times) that are determined to satisfy the climate compatibility condition (S108; No), the display controller 156 displays an incompatibility notification screen.

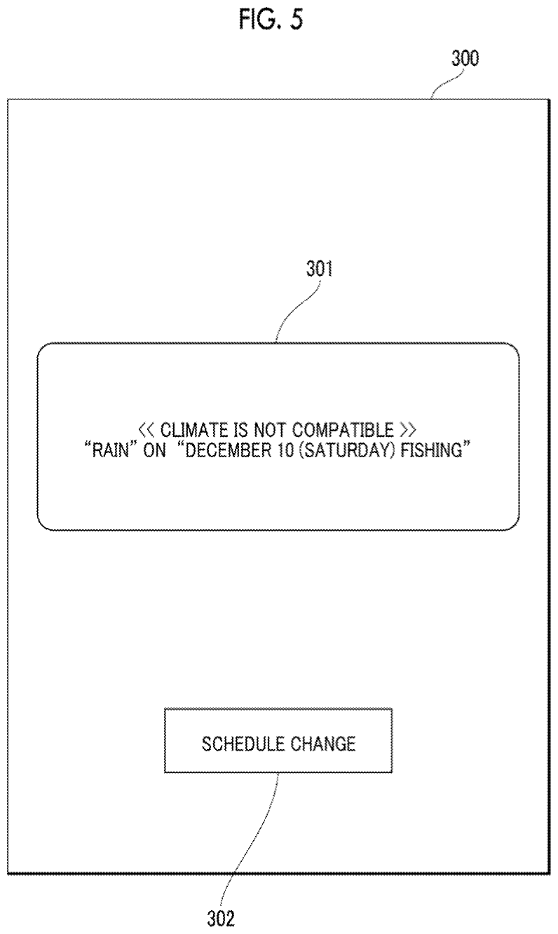

FIG. 5 is a diagram showing an example of an incompatibility notification screen 300. The incompatibility notification screen 300 may include, for example, incompatibility information 301 and a schedule change selection unit 302. Here, the incompatibility information is information indicating that the climate on the scheduled day is not compatible with the genre related to the schedule. For example, in the example shown in FIG. 5, the incompatibility information 301 includes a text of “<<Climate is not compatible>>“rain” on “December 10 (Saturday): Fishing”. The display mode of the incompatibility information is not particularly limited. For example, the form may include information indicating whether any one of columns included in the inappropriate climate table such as “weather”, “air temperature”, “humidity”, and “wind speed” does not satisfy the climate compatibility condition. The schedule change selection unit 302 may be a selection unit to select a schedule registered in the schedule table such that the user changes the schedule as appropriate. When the schedule change selection unit 302 is selected, for example, the display controller 156 may shift to an edit screen of the schedule registered in the schedule table.

(S110) When the determination is made that there are the dates and times (movable dates and times) in which no schedule is registered among the dates and times (substitute candidate dates and times) that are determined to satisfy the climate compatibility condition (S107; Yes), the movement destination date and time deciding unit 154 decides a date and time (movement destination date and time) of a movement destination to which the date and time of the schedule (climate incompatibility schedule) determined in S104 that the climate information on the scheduled day does not satisfy the climate compatibility condition is moved, from among the movable dates and times. The deciding method of the movement destination date and time is not particularly limited. Examples of the date and time that may be decided as the movement destination date and time include a date and time that comes earliest from the present, a date and time of the same day attribute as the climate incompatibility schedule, and a date and time closest to the climate incompatibility schedule.

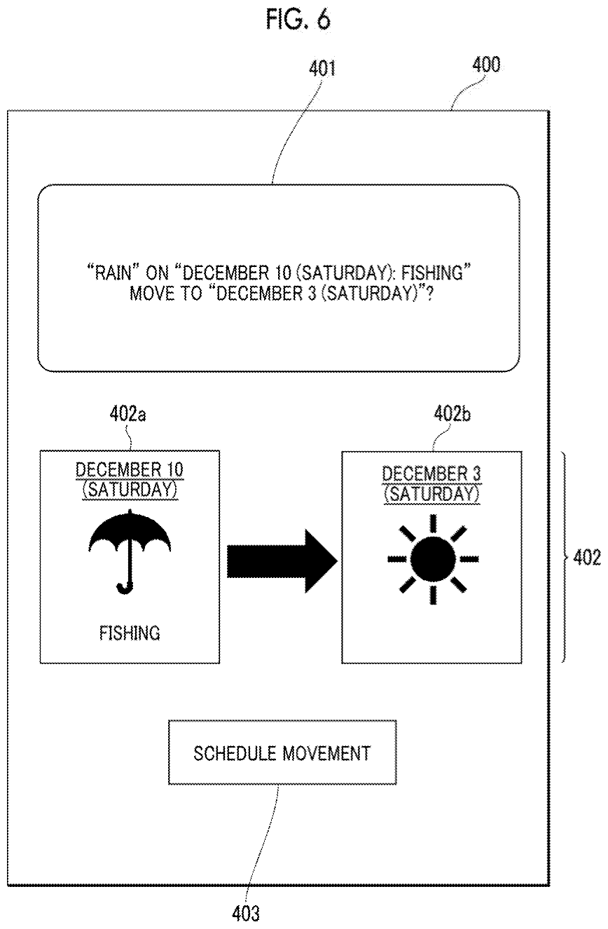

(S111) Next, the display controller 156 displays a schedule movement proposal screen. FIG. 6 is a diagram showing an example of a schedule movement proposal screen 400. The schedule movement proposal screen 400 may include, for example, a schedule movement proposal display unit 401, a climate information display unit 402, and a schedule movement selection unit 403. The schedule movement proposal display unit 401 is information including, for example, contents for proposing the movement of the schedule. The schedule movement proposal display unit 401 may further include information indicating that the climate is incompatible with the climate incompatibility schedule. The climate information display unit 402 may include, for example, a display unit 402a indicating the climate related to the climate incompatibility schedule and a display unit 402b indicating the climate related to the movement destination date and time. When the schedule movement selection unit 403 is selected, the date and time of the climate incompatibility schedule may be changed to the movement destination date and time in the schedule table.

(S112) When the determination is made that there is the schedule (exchangeable schedule) that the “presence or absence of climate influence” is “No” among the schedules registered on the dates and times (substitute candidate dates and times) that are determined to satisfy the climate compatibility condition (S108; Yes), the exchange schedule deciding unit 155 decides a schedule to be exchanged (exchange schedule) with the climate incompatibility schedule from among the exchangeable schedules. The deciding method of the exchange schedule is not particularly limited. Examples of the schedule that may be decided as the exchange schedule include a schedule related to a date and time that comes earliest from the present, a schedule related to a date and time of the same day attribute as the climate incompatibility schedule, and a schedule related to a date and time closest to the climate incompatibility schedule.

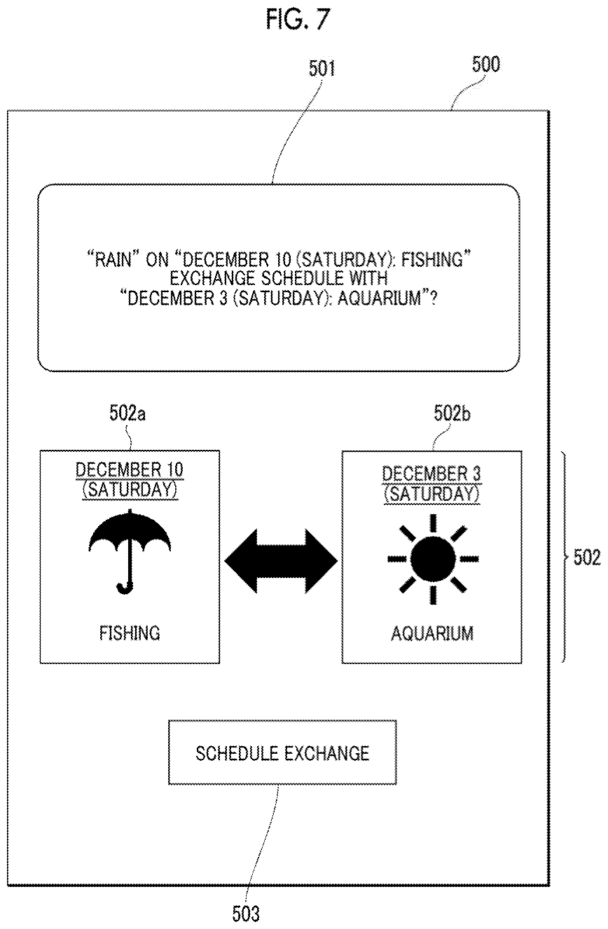

(S113) Next, the display controller 156 displays a schedule exchange proposal screen. FIG. 7 is a diagram showing an example of a schedule exchange proposal screen 500. The schedule exchange proposal screen 500 may include, for example, a schedule exchange proposal display unit 501, a climate information display unit 502, and a schedule exchange selection unit 503. The schedule exchange proposal display unit 501 is information including, for example, contents for proposing the exchange of the schedule. The schedule exchange proposal display unit 501 may further include information indicating that the climate is incompatible with the climate incompatibility schedule. The climate information display unit 502 may include, for example, a display unit 502a indicating the climate related to the climate incompatibility schedule and a display unit 502b indicating the climate related to the movement destination date and time. When the schedule exchange selection unit 503 is selected, the date and time of the climate incompatibility schedule and the date and time related to the exchange schedule may be replaced with each other to exchange the climate incompatibility schedule and the exchange schedule in the schedule table. With the above, the operation processing by the information processing apparatus 1 ends.

As described above, in the embodiment, the information processing apparatus acquires first climate information indicating the climate at the date and time related to a first schedule registered in the schedule table in which at least one schedule including the date and time, the genre, and the place is registered to determine whether or not the first climate information satisfies the climate compatibility condition. The information processing apparatus outputs incompatibility information indicating that the climate at the date and time related to the first schedule is not compatible with the genre related to the first schedule when determination is made that the first climate information does not satisfy the climate compatibility condition. Therefore, the user can change the schedule as appropriate based on the incompatibility information, and thus it is possible to reduce the adverse effect of the climate on the schedule.

The embodiments described above are intended to facilitate the understanding of the disclosure and are not intended to limit the disclosure. Each element included in the embodiments and the disposition, material, condition, shape, size, and the like thereof are not limited to the above examples and can be changed as appropriate. The configurations shown in the different embodiments can be partially replaced or combined with each other.

What is claimed is:

1. A non-transitory storage medium storing a program causing an information processing apparatus to execute the steps of:
acquiring first climate information indicating a climate at a date and time related to a first schedule registered in a schedule table in which at least one schedule including a date and time, a genre, and a place is registered;
determining whether or not the first climate information satisfies a climate compatibility condition; and
outputting incompatibility information indicating that the climate at the date and time related to the first schedule is not compatible with a genre related to the first schedule when determination is made that the first climate information does not satisfy the climate compatibility condition.

2. The non-transitory storage medium according to claim 1 storing the program further causing the information processing apparatus to execute the steps of:
acquiring second climate information for each date and time of a predetermined period in a place related to the first schedule when the determination is made that the first climate information does not satisfy the climate compatibility condition;
determining whether or not there is a substitute candidate date and time satisfying the climate compatibility condition among pieces of the second climate information; and
outputting the incompatibility information when determination is made that there is no substitute candidate date and time satisfying the climate compatibility condition among the pieces of second climate information.

3. The non-transitory storage medium according to claim 2 storing the program further causing the information processing apparatus to execute the steps of:
determining whether or not there is a movable date and time in which no schedule is registered among the substitute candidate dates and times when determination is made that there are the substitute candidate dates and times satisfying the climate compatibility condition among the pieces of second climate information;
deciding a movement destination date and time, from the movable dates and times, to which the first schedule is moved when determination is made that there are the movable dates and times in which no schedule is registered among the substitute candidate dates and times; and
outputting a proposal to move the first schedule to the movement destination date and time.

4. The non-transitory storage medium according to claim 2 storing the program further causing the information processing apparatus to execute the steps of:
determining whether or not there is an exchangeable schedule that is not affected by a climate among schedules registered at the substitute candidate dates and times when determination is made that there are the substitute candidate dates and times satisfying the climate compatibility condition among the pieces of second climate information;
deciding an exchange schedule to be exchanged with the first schedule from the exchangeable schedules when determination is made that there are the exchangeable schedules that are not affected by the climate among the schedules registered at the substitute candidate date and time; and
outputting a proposal to exchange the date and time related to the first schedule with a date and time related to the exchange schedule.

5. The non-transitory storage medium according to claim 1, where the step of determining whether or not the first climate information satisfies a climate compatibility condition is executed based on a predetermined table that defines a standard of climate compatibility.

6. The non-transitory storage medium according to claim 5, wherein the predetermined table includes at least one of weather, air temperature, humidity, and wind speed.

7. An information processing method causing an information processing apparatus to execute the steps of:
determining whether or not a genre related to a first schedule registered in a schedule table in which at least one schedule including a date and time, a genre, and a place is registered is affected by a climate;
acquiring first climate information indicating a climate at a date and time related to the first schedule;
determining whether or not the first climate information satisfies a climate compatibility condition; and
outputting incompatibility information indicating that the climate at the date and time related to the first schedule is not compatible with the genre related to the first schedule when determination is made that the first climate information does not satisfy the climate compatibility condition.

8. An information processing apparatus comprising:
a climate influence determination unit that determines whether or not a genre related to a first schedule registered in a schedule table in which at least one schedule including a date and time, a genre, and a place is registered is affected by a climate;
a climate information acquisition unit that acquires first climate information indicating a climate at a date and time related to the first schedule;
a climate compatibility condition determination unit that determines whether or not the first climate information satisfies a climate compatibility condition; and
a display controller that controls display of incompatibility information indicating that the climate at the date and time related to the first schedule is not compatible with the genre related to the first schedule when determination is made that the first climate information does not satisfy the climate compatibility condition.
